(19) United States
(12) Patent Application Publication
(10) Pub. No.: US 2023/0394465 A1
(43) Pub. Date: Dec. 7, 2023

(54) Categorized Virtual Currency Tracking, Purchasing, and Redemption Systems, and Method of Use and Doing Business

(71) Applicant: Koodbee, LLC, West Orange, NJ (US)

(72) Inventors: Leonard H. Ellis, New York, NY (US); Andrew D. Ellis, West Orange, NJ (US); Mans K. Angantyr, Brooklyn, NY (US)

(73) Assignee: Koodbee, LLC, West Orange, NJ (US)

(21) Appl. No.: 18/146,565

(22) Filed: Dec. 27, 2022

Related U.S. Application Data
(63) Continuation of application No. 16/916,389, filed on Jun. 30, 2020, now abandoned.
Application No. 16/916,389 is a continuation of application No. 14/830,479, filed on Aug. 19, 2015, now abandoned.
(60) Provisional application No. 62/039,189, filed on Aug. 19, 2014.

(51) Int. Cl. G06Q 20/36; G07F 17/32; G06Q 20/06

(52) U.S. Cl. CPC G06Q 20/36; G07F 17/3244; G06Q 20/065

(57) ABSTRACT

A categorized virtual currency tracking, purchasing, and redemption system, method of use, and method of doing business. The method includes providing an automated wallet interface over a communication network, receiving payments from a user for bought-coin virtual currency, providing a tally of the user's bought-coin virtual currency, providing a game in response to a request from the user, providing a tally of any earned-coin virtual currency acquired in the game, debiting at least one of the tallies of bought-coin and earned-coin virtual currency for any payment for the game, and providing through the automated wallet interface a combined tally of the first user's bought-coin and earned-coin virtual currencies.

### CROSS-REFERENCE TO RELATED APPLICATION

This application is a continuation of applicant's prior U.S. non-provisional application Ser. No. 16/916,389 filed 30 Jun. 2020, which is a continuation of applicant's prior U.S. non-provisional application Ser. No. 14/830,479 filed 19 Aug. 2015, which claims priority from U.S. provisional application Ser. No. 62/039,189 filed 19 Aug. 2014, the contents of which are incorporated herein by this reference. The applications are related to:

U.S. non-provisional application Ser. No. 13/787,648 filed 6 Mar. 2013;

U.S. non-provisional application Ser. No. 14/018,828 filed 5 Sep. 2013 as a CIP of the '648 application and issued as U.S. Pat. No. 9,098,805 on 4 Aug. 2015;

U.S. non-provisional application Ser. No. 14/788,403 filed 30 Jun. 2015 as a continuation of the '828 application;

U.S. provisional application serial no. 61/750,906 filed 10 Jan. 2013, from which the '648 application claims priority; and

U.S. provisional application serial no. 61/607,478 filed 6 Mar. 2012, from which the '648 application claims priority.

The contents of all of the preceding applications are incorporated herein by this reference.

### COPYRIGHT NOTICE

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyright rights.

### INVENTORS' VIEW OF SOME ASPECTS OF THE PRIOR ART

Virtual worlds and virtual environments incorporating the acquisition and use of a virtual currency are well-known in the art. In some virtual environments, system users acquire virtual currency through multiple mechanisms, such as, for example, executing an exchange of legal currency for virtual currency, transfers of virtual currency from other users, system awards of virtual currency, and winnings from participation in games or activities. The virtual currency can be represented by indicia, such as virtual coins or virtual dollars. As system users interact with the environment, the amount of virtual currency can increase or decrease based on events that occur in the virtual environment.

Conventional systems supporting the use of virtual currency and virtual transactions generally implement a single-category conversion approach where legal currency is converted to virtual currency where all virtual currency is treated similarly. For example, an amount of virtual currency can be purchased by exchanging legal currency for virtual currency based upon some exchange rate. The virtual currency is then used in the virtual environment and the amount available to the user increases and decreases as purchases and events occur. In many of these systems, once the virtual currency is purchased, no amount of that currency is redeemable for the purchase of assets with real world value. This method of locking real world currency into the system can reduce willingness of users to purchase virtual currency, thus reducing the overall level of action and participation in the system, and reducing profit realized by the system owner or operator.

### BRIEF SUMMARY OF SOME ASPECTS OF CATEGORIZED VIRTUAL CURRENCY TRACKING, PURCHASING, AND REDEMPTION SYSTEMS, METHODS OF USE, AND METHODS OF DOING BUSINESS

The inventors believe they have discovered problems and issues with prior art virtual currency tracking, purchase and redemption system. Some of the problems and issues are identified above. This application describes novel categorized virtual currency tracking, purchase, and redemption systems, methods of use, and methods of doing business. In some embodiments the system provides a virtual currency for use in a virtual environment that can include purchases or transfers of virtual assets, goods, or privileges in a virtual economy, virtual game, virtual activity, or the like. In some embodiments at least some of the virtual currency is redeemable for one or more categories of virtual goods, virtual activity participation, and virtual game play. In some instances, virtual currency is transferrable to one or more other users in the virtual environment.

In some implementations virtual currency is identified as belonging to one of multiple categories, such as bought virtual currency and earned virtual currency. The system can include rules for identifying amounts as belonging to one or more categories of virtual currency, and for determining changes to the categorization of amounts. In some implementations the rule strategy is directed to obtaining a maximized bought virtual currency categorized amount within a set of rule constraints. Such an implementation can, if desired, support conformance with one or more external constraints, such as certain regulations applicable to the use, operation, or functions of such systems, while at the same time improving availability of currencies for purchases and redemptions of interest. Such system features can increase the overall level of action and participation in the system, thereby increasing profits realized by the system owner or operator.

In some embodiments categorized virtual currency tracking is implemented as part of a social gaming system. The categorized virtual currency system can support purchase of in-game virtual assets with no real-world value using virtual currency categorized as earned virtual currency, and purchase of assets with a real-world value using virtual currency categorized as bought virtual currency. Real-world assets can include, for example, assets that exist in the real world, such as merchandise, or assets that have utility in the real world, such as information.

For example, in some cases one or more rules include:

a) a rule directing the system to reduce an amount categorized as bought virtual currency if and only if an amount categorized as earned virtual currency is not sufficient to meet a given transaction amount;

b) a rule directing the system to increase the amount categorized as bought virtual currency in advance of categorizing excess amounts as earned virtual currency;

c) a rule directing the system to reduce the amount categorized as an earned virtual currency before reducing the amount categorized as bought virtual currency; and

d) a rule directing the system to increase the amount categorized as an earned virtual currency only after reducing the amount categorized as bought virtual currency.

Some embodiments employ a wallet metaphor that may be provided to a user as a visual display of a wallet. Just as a person might look in a physical wallet to see how much money is present; to pull out a credit card for making a purchase; or to retrieve business cards, notes, or other bits of information, so the users of embodiments of a virtual currency tracking system might look at their virtual wallets for analogous purposes. A virtual wallet according to some embodiments includes multiple summary screens and transaction screens.

System award currency may be added to a total of earned virtual currency. Awarded currency for certain types of mode-based play, such as expert mode play, can be added to the total of earned virtual currency. Activity and game buy-ins can be funded by amounts from available earned virtual currency, with any remaining amount funded by amounts available from available bought virtual currency. Awards, for example pay-outs, attributable to an activity or game can be added to the virtual currency category from which the buy-in was funded. For example, winnings can be distributed as win-backs in which an amount equal to the bought virtual currency used to fund the buy-in is first added back to the bought virtual currency amount, with any excess added to the earned virtual currency amount.

Purchased virtual currency can be added to the bought virtual currency. Subscriptions, such as monthly refills, are treated as virtual currency and can be added to the bought virtual currency.

In some implementations, virtual goods, such as virtual trophies, can only be purchased using earned virtual currency. Similarly, in certain instances, assets with real world value, such as information, can only be purchased using bought virtual currency. In other embodiments, certain types of goods can be purchased with bought virtual currency, earned virtual currency, or both.

In certain instances, refunds may be issued, where the a portion of the refund amount equal to the bought virtual currency used to fund the buy-in is first added back to the bought virtual currency amount, with any excess added to the earned virtual currency amount.

In some embodiments transaction history can be filtered by transaction type. These types may include refills, buy-ins, pay-outs, awards, payments, and refunds. Details of various types of transactions can be displayed, including type of transaction, date, amount, description of transaction, category and amount of a draw and a distribution, available amount of virtual currency for each category, and total amount of available virtual currency.

In some instances a purchase interface includes an exchange between virtual currency and real world currency. Currency amounts can be displayed such that they automatically display a calculated amount based on the value entered in the opposing currency control and a pre-defined currency exchange rate. The purchase interface can also include an interface for receiving credit card information or other electronic payment credentials. A similar purchase interface can be displayed for recurring purchase of bought virtual currency. Purchase interfaces can automatically display stored electronic purchasing credentials and prompt for alternative electronic purchase credentials.

The foregoing and other aspects of the systems and methods disclosed herein can be utilized as a business and, if desired, to generate revenue. Revenue sources can include, for example, margins on purchases of real world assets where such purchases are funded with bought virtual currency; buy-in purchases for access to or participation in activities such as games at least to the extent buy-in purchases are funded by bought virtual currency; and fee access to a premium level of play or to a private game play, for example to the extent buy-in purchases are funded by bought virtual currency.

This summary recites some aspects of the present specification, but neither the background nor this summary are intended to be limiting. There are other novel and advantageous aspects of the specification. The scope of an issued claim based on this specification is to be determined by the claim as issued and not by whether it addresses an issue noted in the background or provides a feature, problem solution, or advantage recited in this summary.

### BRIEF DESCRIPTION OF THE DRAWINGS

The drawings illustrate features of the embodiments by example.

FIG. 1 is a block diagram of a digital processing environment in which a categorized virtual currency tracking, purchasing, and redemption system can be implemented according to an embodiment.

FIG. 2 is a block diagram of the internal structure of a computer used in the environment of FIG. 1.

FIG. 3 is a wire diagram of a wallet interface for a categorized virtual currency tracking, purchasing, and redemption system according to an embodiment.

FIG. 4 is a wallet entity diagram showing various classes of wallet service for implementing the wallet interface of FIG. 3.

FIG. 5 is a database table diagram showing tables that support the wallet service classes of FIG. 4.

FIGS. 6A through 6E are tables showing events and currency amounts:

FIG. 6A is a table of a user's account;

FIG. 6B is a table listing game transactions;

FIG. 6C is a table of currency adjustments for a wallet associated with the transactions of FIG. 6B;

FIG. 6D is a table of events associated with the transactions of FIG. 6B;

FIG. 6E is a table listing adjustments associated with the transactions of FIG. 2;

FIGS. 7A through 7C are a table listing the events and currency amounts of FIGS. 6A through 6E organized by game.

FIG. 8 is a wireframe of a full activity listing for a wallet interface.

FIG. 9 is a wireframe of a filtered activity listing filtered by refill transaction type for a wallet interface.

FIG. 10 is a wireframe of a filtered activity listing filtered by buy-ins transaction type for a wallet interface.

FIG. 11 is a wireframe of a filtered activity listing filtered by pay-outs transaction type for a wallet interface.

FIG. 12 is a wireframe of a filtered activity listing filtered by awards for a wallet interface.

FIG. 13 is a wireframe of a filtered activity listing filtered by payments transaction type for a wallet interface.

FIG. 14 is a wireframe of a filtered activity listing filtered by refunds transaction type for a wallet interface.

FIG. 15 through FIG. 27 are detailed transaction listings for each of the transactions of FIG. 2.

FIG. 28 is a purchase interface for one-time purchase of bought virtual currency.

FIG. 29 is a purchase interface for recurring purchase of bought virtual currency.

FIG. 30 is a flowchart illustrating a process for debiting coins from a wallet for a buy-in.

FIG. 31 is a flowchart showing how coins from a pay-out are credited to a user's wallet.

FIG. 32 is a flowchart illustrating how token values are calculated in a paid game.

FIG. 33 is a flowchart depicting the processing of a user's pick.

### DETAILED DESCRIPTION

Broadly, this disclosure is directed towards categorized virtual currency tracking, purchasing, and redemption systems; methods of using such systems; and methods of doing business with such systems. The following description provides examples, and does not limit the scope, applicability, or configuration set forth in the claims. Changes may be made in the function and arrangement of elements discussed without departing from the scope of the disclosure. Various embodiments may omit, substitute, or add various procedures or components as appropriate. Methods described may be performed in an order different from that described, and various steps may be added, omitted, or combined. Also, features described with respect to certain embodiments may be combined with features of other embodiments.

Alphabetical glossary of terms used in this patent application:

| | |
|---|---|
| Auto | A Refill in which a user's Wallet is configured |
| Reload | to automatically purchase Bought Coins as |
| | needed to prevent the user's balance of Coins |
| | from falling below a specified threshold. |
| Award | A system-driven addition of an Earned Coin to |
| | a user's Wallet based on a user's accuracy |
| | in a Free Game. |
| Bought Coin | A coin purchased with In-World Currency. |
| Buy-In | An act of using a Bought Coin or an Earned |
| | Coin to participate in a Paid Game. |
| Coin | An In-Game Currency unit of value. |
| Earned Coin | A Coin provided by the system as an incentive |
| | awarded for superior game play in a Free Game |
| | or as a Winning beyond a Win-Back in a Paid |
| | Game. |
| Free Game | A Game that does not provide a Pay-Out. |
| | Earned Coins may be awarded to a user based |
| | on that user's accuracy in that Free Game. |
| Game | A playable instance of a Program |
| In-Game | Mediums of exchange for a system. |
| Currency | |
| In-World | Money in any form that is in actual use or |
| Currency | circulation and that functions as a |
| | medium of exchange. |
| Monthly | A Refill in which Bought Coins are |
| Refill | automatically added to a user's Wallet |
| | at recurring intervals according to a plan |
| | subscribed to by the user. |
| One-Time | A Refill in which a user purchases Bought |
| Refill | Coins using In-World Currency |
| Payment | An act of using In-Game Currency to make a |
| | purchase other than a Buy-In. |
| Pay-Out | A Winning from a Paid Game. |
| Pick | A prediction weighted by an amount of In- |
| | Game Currency taken from a user's Stake. |
| | A user can make a Pick on a play by a |
| | competitor in a Game. A Pick in an In-World |
| | Currency gambling context would be called a |
| | “bet”. |
| Program | One or more competitive contests with mutually |
| | exclusive outcomes. |
| Refill | An act of adding a Bought Coin to a user's |
| | Wallet, including any of a One-Time Refill, |
| | a Monthly Refill, and an Auto Reload. |
| Refund | An act of restoring In-Game Currency to a user's |
| | Wallet based on an event such as a canceled |
| | Game or a faulty Refill transaction. |
| Sponsorship | An arrangement in which a first user is |
| | authorized to make a wager on behalf of a |
| | second user with Coins from the second user's |
| | Wallet. |
| Stake | Number of tokens given to each user to make |
| | picks in a Game. |
| Staking | An arrangement in which a first user is authorized |
| | to make wagers on behalf of a second user and |
| | in which any Winnings are shared by both users. |
| Token Value | The value of a token; this value is calculated by |
| | dividing a Buy-In by a Stake. |
| Wallet | An interface that gives a user information and |
| | through which the user can perform actions. |
| Win-Back | Use of Winnings to restore to a user's Wallet a |
| | Bought Coin that was previously used for a Buy- |
| | In in a Paid Game. |
| Winning | A product of a Pay-Out and a Token Value. |

Certain embodiments of categorized virtual currency tracking, purchasing, and redemption systems and methods are described with reference to methods, apparatus (systems), and computer program products that can be implemented by computer program instructions. These computer program instructions can be provided to a processor of a general purpose computer, special purpose computer, mobile computing device, or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a computer or other programmable data processing apparatus to operate in a particular manner, such that the instructions stored in the computer-readable memory produce an article of manufacture including instruction means which implement the acts specified herein. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified herein.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed with a general purpose processor, a digital signal processor (DSP), an application-specific integrated circuit (ASIC), a field programmable gate array (FPGA) or other programmable logic device, discrete gate, transistor logic, discrete hardware components, or any combination thereof designed to perform the functions described herein. A general purpose processor can be a microprocessor, but in the alternative, the processor can be any conventional processor, controller, microcontroller, or state machine.

A processor can also be implemented as a combination of computing devices such as, for example, a combination of a DSP and a microprocessor, a plurality of microprocessors, one or more microprocessors in conjunction with a DSP core, or any other such configuration. The blocks of the methods and algorithms described in connection with the embodiments disclosed herein can be embodied directly in hardware, in a software module executed by a processor, or in a combination of the two.

A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a computer terminal. In the alternative, the processor and the storage medium can reside as discrete components in a computer terminal.

Depending on the embodiment, certain acts, events, or functions of any of the methods described herein can be performed in a different sequence, can be added, merged, or left out altogether (for example, not all described acts or events are necessary for the practice of the method). Moreover, in certain embodiments acts or events can be performed concurrently, for example, through multi-threaded processing, interrupt processing, or multiple processors or processor cores, rather than sequentially. Moreover, in certain embodiments, acts or events can be performed on alternate tiers within the architecture.

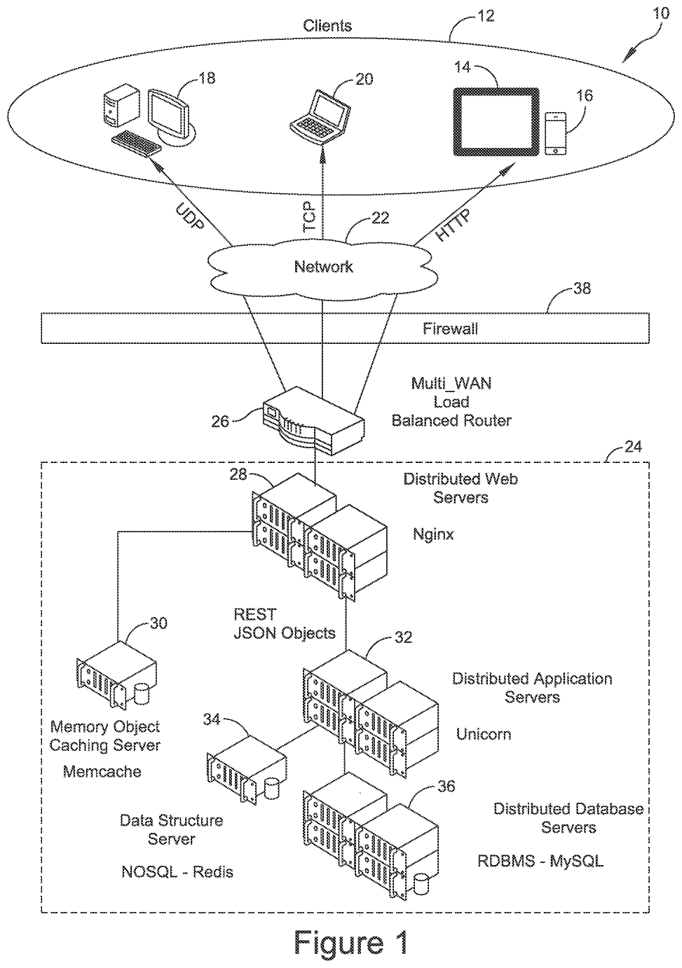

FIG. 1 illustrates a computer network or similar digital processing environment generally 10 in which the systems and methods disclosed can be implemented. These systems and methods can also run on different architectures that include a LAN; a WAN; a stand-alone PC; a stand-alone mobile device; stand-alone, clustered, or networked mini or mainframe computers; or the like. These systems and methods can be implemented by various client devices generally 12 such as one or more of a notebook computer 14, a mobile phone 16, a desktop computer 18, and a laptop computer 20 that communicate through a network 22 with a server system 24.

The components shown in FIG. 1 are representative of many computing arrangements that can support the systems and methods disclosed herein. In one embodiment, the software implementing the prediction processing system runs in the Linux® environment. In another embodiment, the software is implemented to run in other environments such as Windows® or UNIX®, or in any hardware having enough power to support timely operation of software, In some implementations, the Ubuntu® 12.04 LTS Linux distribution is deployed on one or more server computers such as the server system 24 . In an alternate embodiment, computers are deployed as virtual instances rather than physical computers.

In some embodiments a load balancing router 26, for example a Peplink® Multi Wan Router, carries network traffic between the network 22 and the server system 24. The server system 24 includes one or more web server computers 28 which in some embodiments are distributed instances of an Nginx web server distribution. A memory object server 30 deploying a caching model such as, for example, memcache, and one or more distributed application servers 32 are communicatively coupled to one or more of the distributed web servers 28.

The distributed application servers 32 may run instances of application servers, for example Unicorn®. The application servers 32 are communicatively coupled to one or more other devices, for example a data structure server 34 and distributed database servers 36 hosting one or more persistent data stores. These data stores can be distributed databases such as, for example, MySQL ® or Postgres or high performance key/value stores such as Redis® that can be used to queue queries and to store nodes and derivative data.

The various computers and devices can pass information as unstructured data, structured files, structured data streams such as XML, structured data objects, and structured messages. In some embodiments the various computers in the server system 24 run software to implement centralized persistent data storage and retrieval. Some embodiments may include a firewall 38 through which traffic flows to or from the router 26.

The client devices generally 12 may communicate over various protocol, for example UDP, TCP/IP, or HTTP. The client devices 12 and the computers in the server system 24 provide processing, storage, and input/output devices executing application programs. The client devices 12 can be linked through the communications network 22 or other communication facilities to other client devices (not shown) or other server computers (not shown).

The network 22 can be a local area network or a wide area network that is part of a remote access network, a global network (e.g., the Internet), a worldwide collection of computers, or gateways that currently use respective protocols (TCP/IP, UDP, and the like) to communicate with one another. The various client devices 12 may each execute and operate instances of applications accessing the system servers.

Many of the components discussed as separate units may be combined into one unit. An individual unit may be split into several different units. Further, the various functions could be contained in one computer or spread over several networked computers or devices. The identified components may be upgraded and replaced as associated technology improves and advances are made in computing technology.

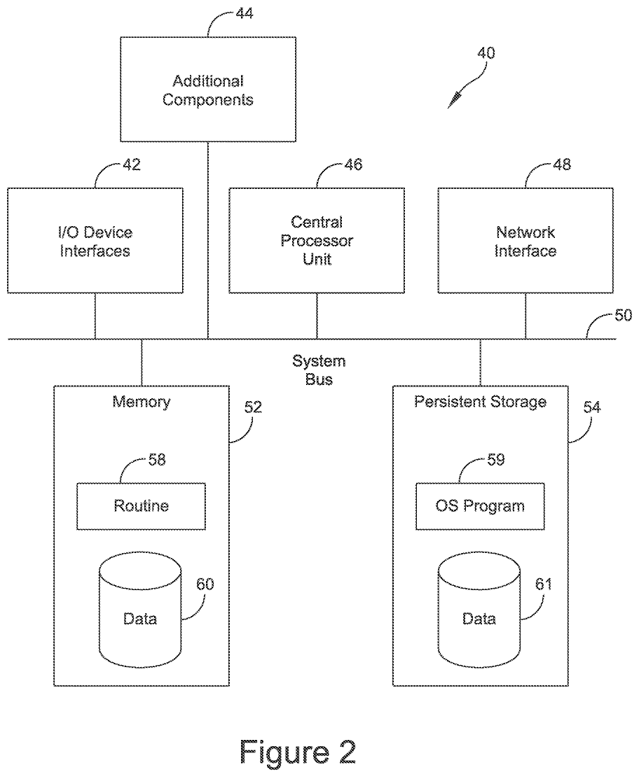

FIG. 2 depicts the internal configuration of a computer generally 40 that may be used in the server system 24. The computer 40 includes one or more I/O device interfaces 42, optional additional components 44, a central processor unit 46, and a network interface 48 all interconnected through a system bus 50. The additional components 44 may include additional memory storage, digital processors, network adapters, I/O devices, and the like.

The bus 50 may be a shared conduit connecting different elements of a computer system (for example, processor, disk storage, memory, input/output ports, network ports, and the like) and carrying information between those elements. The I/O device interface 42 is attached to the system bus 50 to connect various input and output devices (for example keyboards, mouses, touch-screens, displays, printers, speakers, and the like — not shown).

The network interface 48 provides connection to various other devices that may be attached to a network such as the network 22.

A memory unit 52 and a persistent storage unit 54 such as a disk drive, both in communication with the bus 50, provide volatile and non-volatile storage, respectively. The memory unit 52 may contain software such as a routine 58. The persistent storage unit 54 may contain an operating system (OS) program 59. Both units may contain data 60 and 61, respectively.

In one embodiment, the processor routines 58 and data 60 comprise a computer program product, including a computer readable medium (e.g., a removable storage medium such as one or more DVDROM's, CD-ROM's, diskettes, tapes, etc.) that provides at least a portion of the software instructions for the system. A computer program product that combines routines 58 and data 60 may be installed by any suitable software installation procedure, as is well known in the art. In another embodiment, at least a portion of the software instructions may also be downloaded over a cable, communication, or other wireless connection.

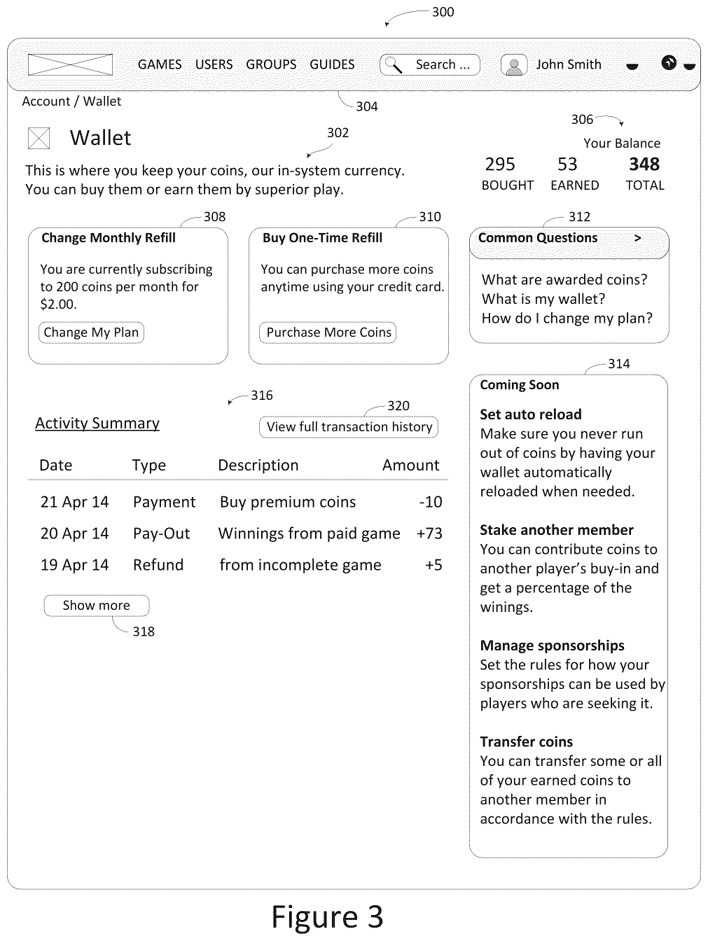

FIG. 3 depicts a wallet interface generally 300. The wallet interface enables a user and the system to communicate. Through the wallet the user can get such information as account details, a summary of the user's activity, a history of the user's transactions, details of the user's transactions, and information generated by the system. And through the wallet the user can perform such transactions as one-time and additional purchases of coins.

FIG. 3 provides just one example of how a wallet interface can be configured; many variations are possible. In this example, an introduction 302 tells a user what the wallet does. A menu bar 304 gives the user's name and optionally a photo. Through the menu bar 302 the user can select games, users, groups, guides, or other choices as may be provided, and the user can search using a search window. A balance summary 306 gives the quantity of the user's bought coins, earned coins, and total coins (295, 53, and 348, respectively). Windows may be provided for various actions the user might want to perform; in this example a window 308 provides for changing a monthly refill amount and a window 310 provides for buying a one-time refill. Common questions can be scrolled through and answers obtained in a window 312. A window 314 can be used by the system to give general information to the user; in this example the window 314 gives a preview of features soon to be added to the system. An area 316 is used for more detail; in this example an activity summary is provided, listing a few recent activities that were performed by the user, and the user can see more activities or view a full transaction history by using buttons 318 and 320, respectively.

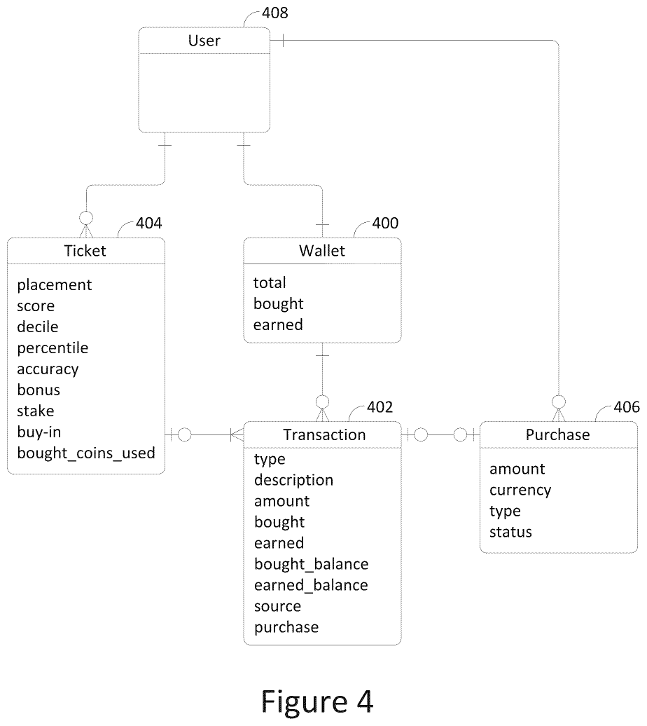

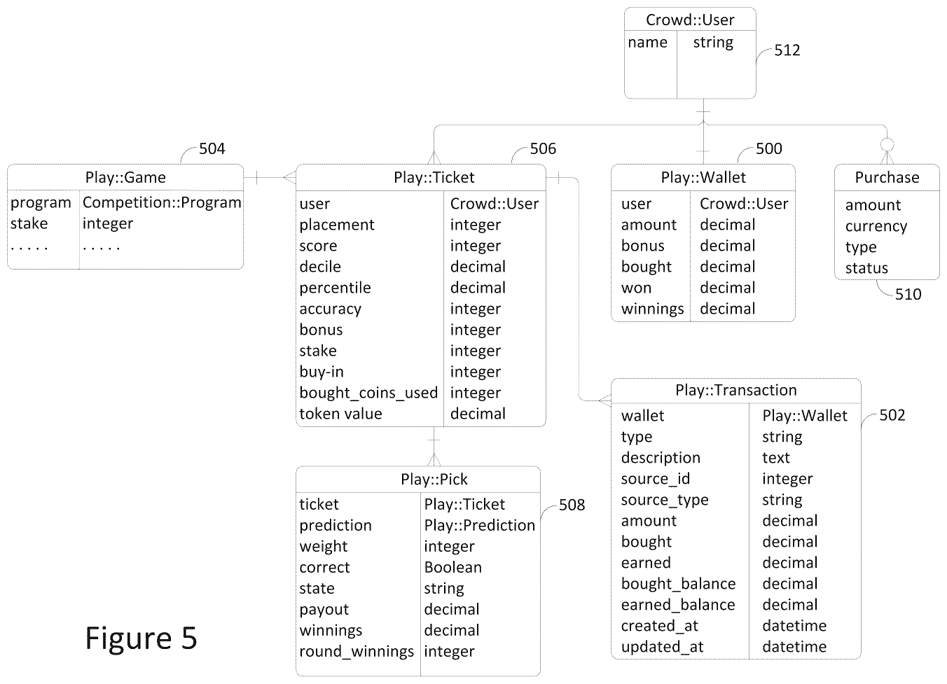

FIG. 4 is a wallet entity diagram showing wallet service classes that can implement the wallet system according to some embodiments. FIG. 5 shows database tables that support the wallet service classes of FIG. 4.

Referring to FIG. 4 and FIG. 5, a Play::Wallet class (object model) 400 stores total bought coins, total earned coins, and total coins for a user. A play_wallets database table 500 supports this class. A Play::Transaction class 402 stores all transactions for a given user and source. A play_transactions database table 502 supports this class. The values for bought and earned coins are stored as decimal values to account for accuracy and placement calculations but are rounded-up and displayed as integers in the wallet interface.

The Play::Wallet object model 400 may have many transactions reflecting events that affect the balance of coins in the wallet. These transactions are stored in the PLAY_TRANSACTIONS table 502. The following attributes are available on the Play::Wallet object model 402:
Play::Transaction Type
Play::Transaction Description
Play::Transaction Amount
Play::Transaction Bought
Play::Transaction Earned
Play::Transaction Bought_Balance
Play::Transaction Earned_Balance
Play::Transaction Source
Play::Transaction Purchase

Play::Transaction Type: the Wallet transaction has the following categories:
1. Refill
2. Buy-In
3. Pay-Out
4. Award
5. Payment
6. Refund

Play::Transaction Description: further information about the transaction is stored in the Description column. This generated based on information in the Transaction Source object. For example, a transaction in the refill category could describe what type of refill was recorded, such as one-time refill, monthly refill, or auto-reload.

Play::Transaction Amount: each wallet transaction, whether it is a refill, buy-in, or pay-out, has a total transaction amount. This amount is either a negative or a positive decimal number. This amount is stored in the amount column, and also recorded as subtotals in the earned and bought columns.

Play::Transaction Earned: the transaction will record the amount added or subtracted from the wallet earned coins in the transaction earned column.

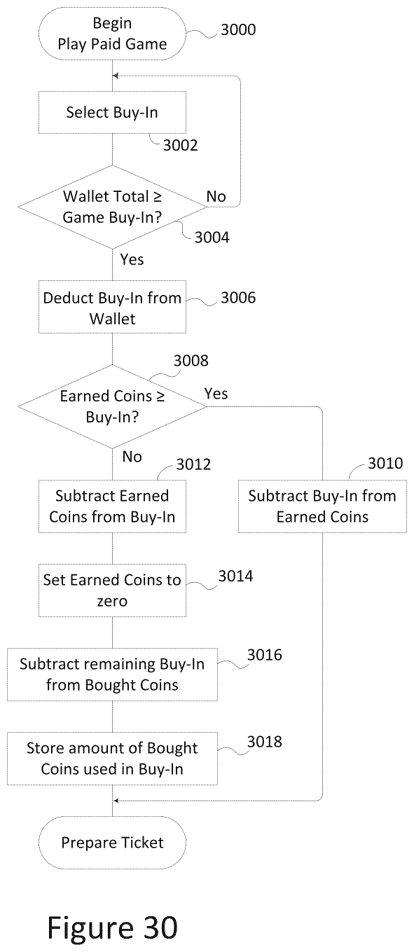

Play::Transaction Bought: the transaction will record the amount added or subtracted from the wallet bought coins in the transaction bought column. The logic for the earned and bought (credit and debit) calculations can be found in FIGS. 30A and 30B to be described presently. For example, a refill transaction of 50 coins is recorded as 50 in transaction amount column, and 50 in the transaction bought column, and a buy-in at 40 coins is recorded in a Play::Transaction as −40 in the transaction amount column, as −23 in the transaction earned column, and as −17 transaction bought column.

Play::Transaction Earned_Balance: before the wallet transaction is stored, the wallet balance of earned coins is updated by adding the transaction earned amount (which may be positive or negative) to the wallet earned column. The resulting wallet earned amount is then stored in the transaction earned balance column. This transaction between the wallet and transaction records is atomic.

Play::Transaction Source: A wallet transaction contains a reference to the source object that triggered the change in the wallet total. The most common source objects are buy-ins and refills. For example. wallet transactions for buy-ins, pay-outs, and awards all refer to a game ticket as source objects. A wallet refill transaction, which involves the purchase of in-game currency using in-world currency, would point to a separate database record for the credit card transaction as its source object.

Other classes shown in FIG. 4 include: Play::Ticket 404 which may have many transactions, Play::Purchase 406 which has one transaction, and Play::User 408 which has one wallet but can have many tickets and many purchases.

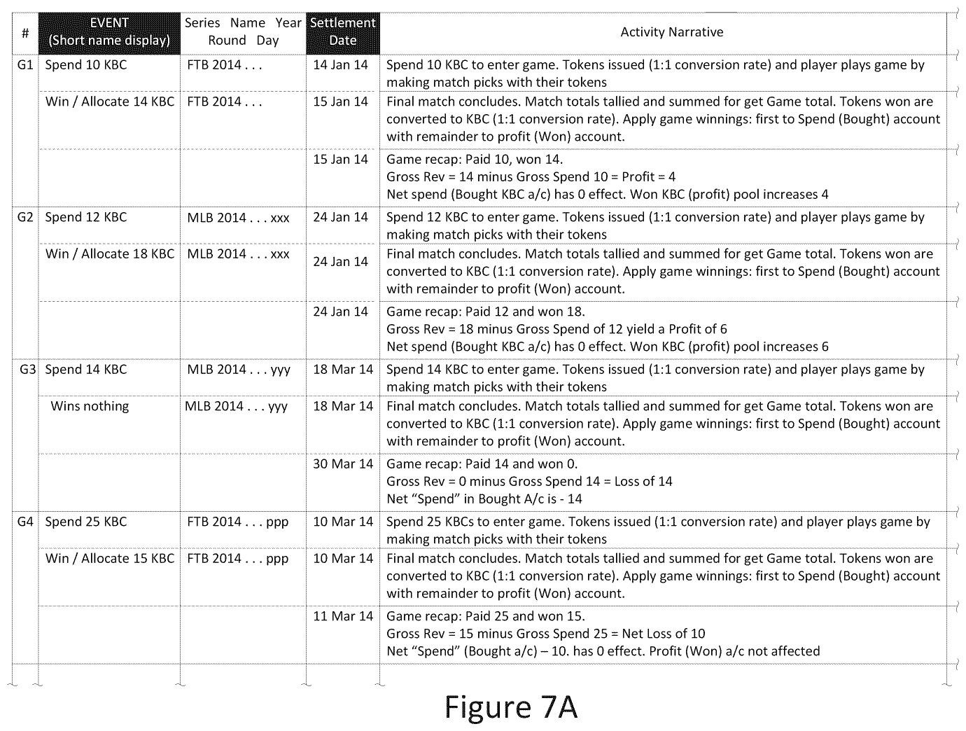

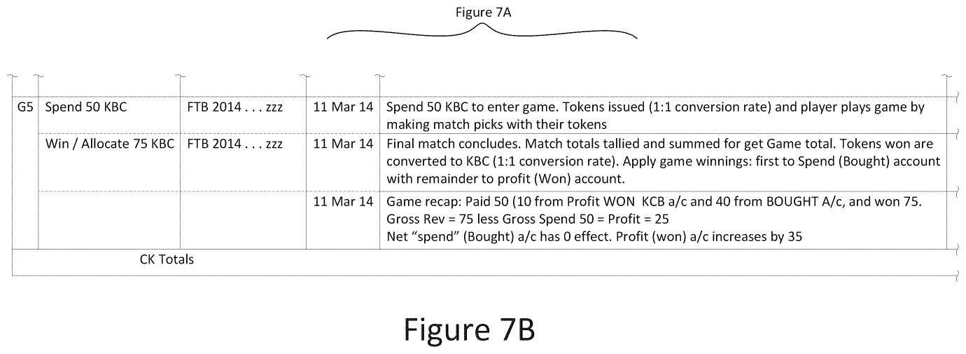

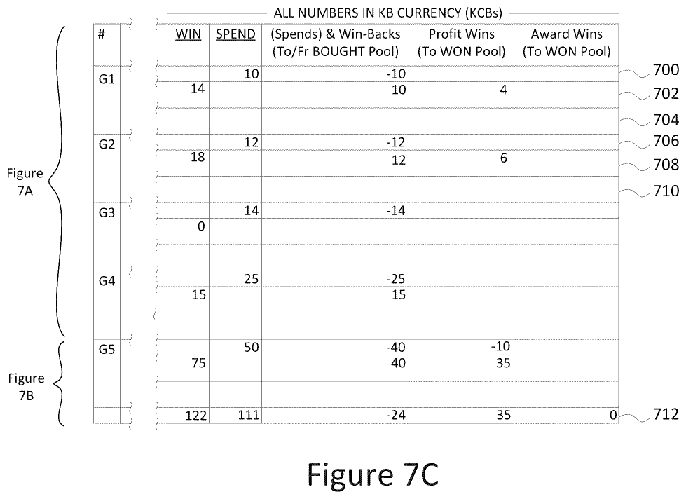

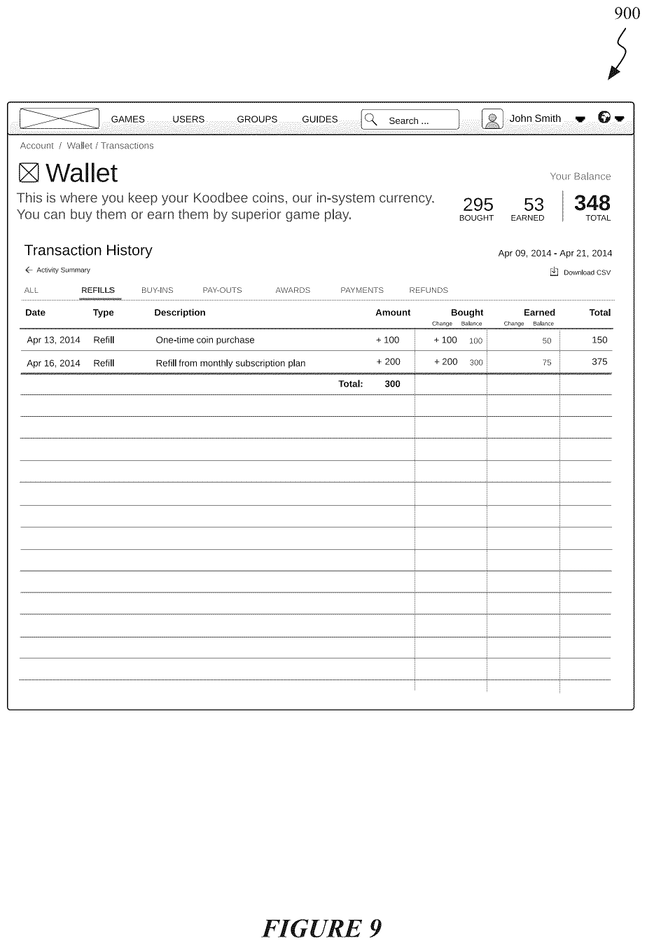

Other database tables shown in FIG. 5 include: a play_game table 504 (see reference numeral 714 in FIG. 7N of application Ser. No. 14/018,828 and accompanying text); a play_ticket table 506 (see reference numeral 717 in FIG. 7Q and reference numeral 752 in FIG. 9C, both of application Ser. No. 14/018,828, and accompanying text); a play_pick table 508 (see reference numeral 718 in FIG. 7R of application Ser. No. 14/018,828, and accompanying text); a play_purchase table 510, and a crowd_user table 512 (see reference numeral 502 in FIG. 4B of application Ser. No. 14/018,828, and accompanying text). A crowd_user can have: one wallet which in turn can have zero or more transactions; zero or many purchases; and zero or many tickets each of which can have zero or many transactions and zero or many picks. A play_game can have zero or more tickets.

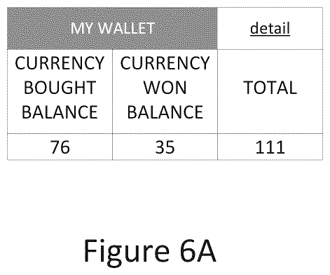

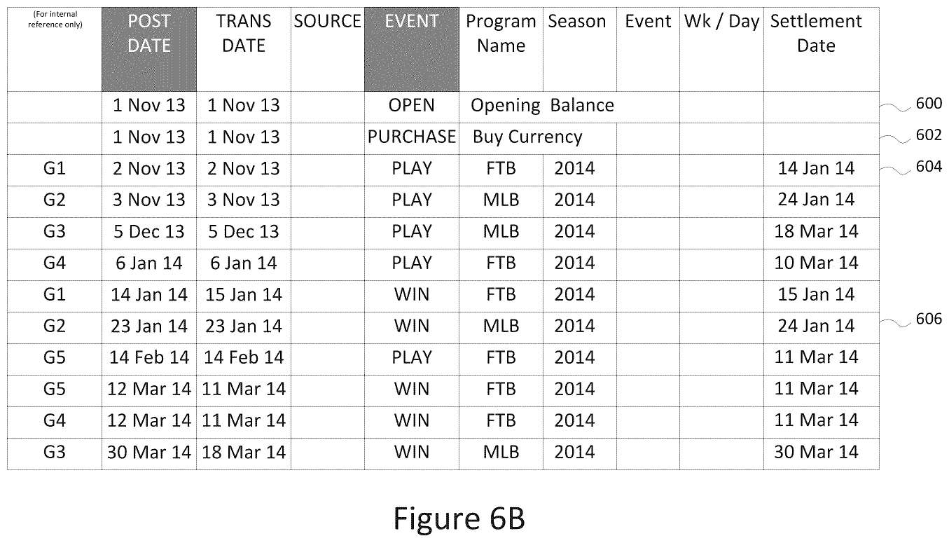

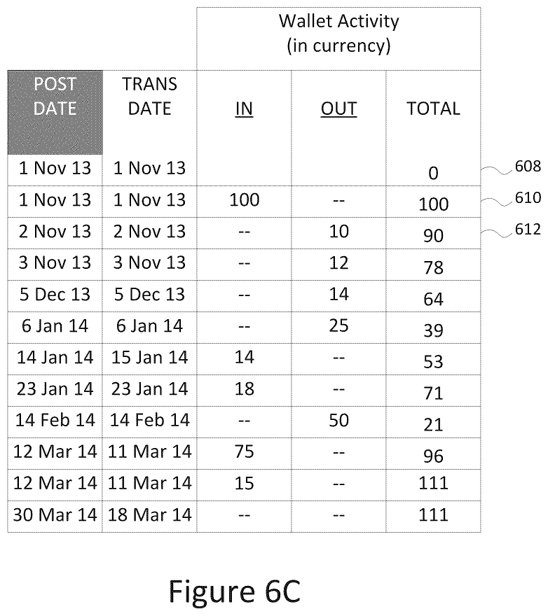

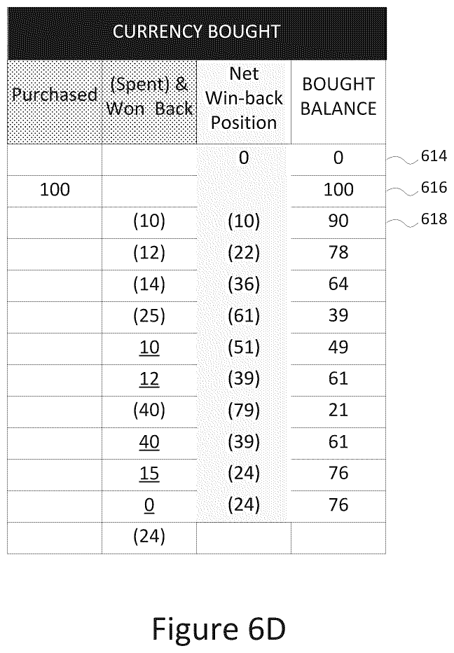

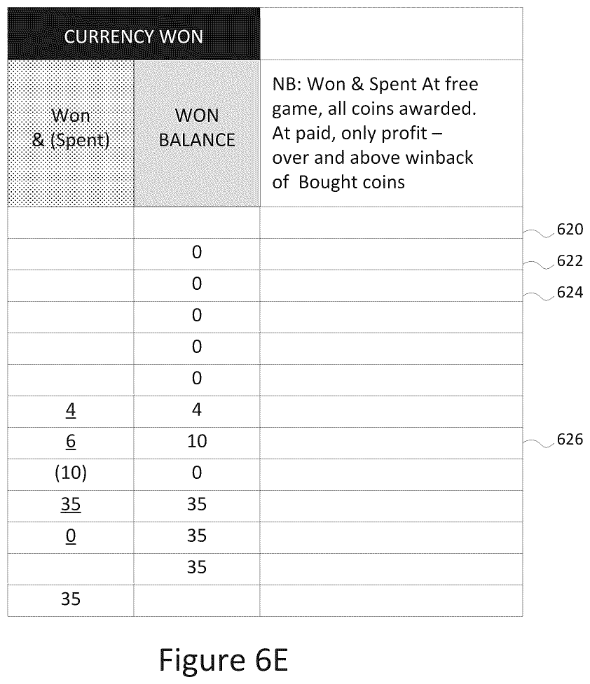

FIG. 6A shows a user's account including a currency bought balance, a currency won balance, and a total balance. This example shows a user having a currency bought balance of 76 coins, a currency won balance of 35 coins, and a total of 111 coins.

FIG. 6B shows a user's game transactions over a period of about five months. In this example, the user's account was opened and currency bought on 1 Nov. 13 (rows 600 and 602, respectively). A game identified as an FTB game was played on 2 Nov. 13 in the 2014 season and any coins due were settled on 14 Jan. 14 (row 604). A game identified as an MLB game was played on 23 Jan. 14, resulting in a win, and any coins due were settled on 24 Jan 14. (row 606). The other rows have similar meanings.

FIG. 6C shows currency adjustments for a wallet associated with the transactions of FIG. 6B. In this example, a row 608 shows adjustments of 0 associated with the account opening transaction of row 600. A row 610 shows an adjustment of 100 coins “in”, resulting in an increase of the total to 100, associated with the purchase of currency of row 602. A row 612 shows an adjustment of 10 coins “out”, resulting in a decrease of the total to 90, associated with the game of row 604; and so on.

FIG. 6D shows events associated with the transactions of FIG. 6B. A row 614 corresponds with the row 600; a row 616 corresponds with the row 602; a row 618 corresponds with the row 604; and so on.

FIG. 6E shows is a table listing adjustments associated with the transactions of FIG. 6B. Rows 620, 622, and 624 correspond with rows 600, 602, and 604, respectively, all showing a zero “won” balance. A row 626 corresponds with the row 606 showing a “won” balance of 10; and so on.

FIGS. 7A through 7C show events and currency amounts organized by game and extending over five example games. Events and currency amounts of a first game G1 are shown in rows 700, 702, and 704; events and currency amounts of a second game G2 are shown in rows 706, 708, and 710, and so on for games G3, G4, and G5. Finally, CK totals over all five games are shown in a row 712. The first row pertaining to game G1, row 700, shows a user spending to enter the game, in this instance 10 coins; the second row 702 shows a win following a final match of the game G1, resulting in a win of 14 coins; the third row 704 gives a recap of the game G1. Events and currency amounts of a game G2 are presented in rows 706, 708, and 710, similar to the rows 700, 702, and 704, respectively. The other games are similarly presented. Finally a CK total extending over all five games is presented in a row 712,

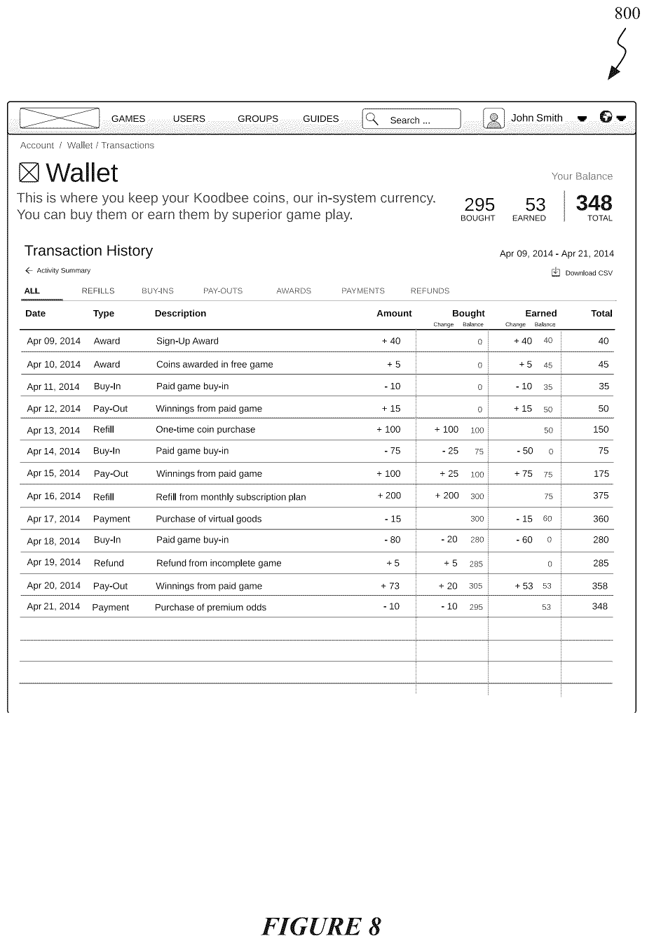

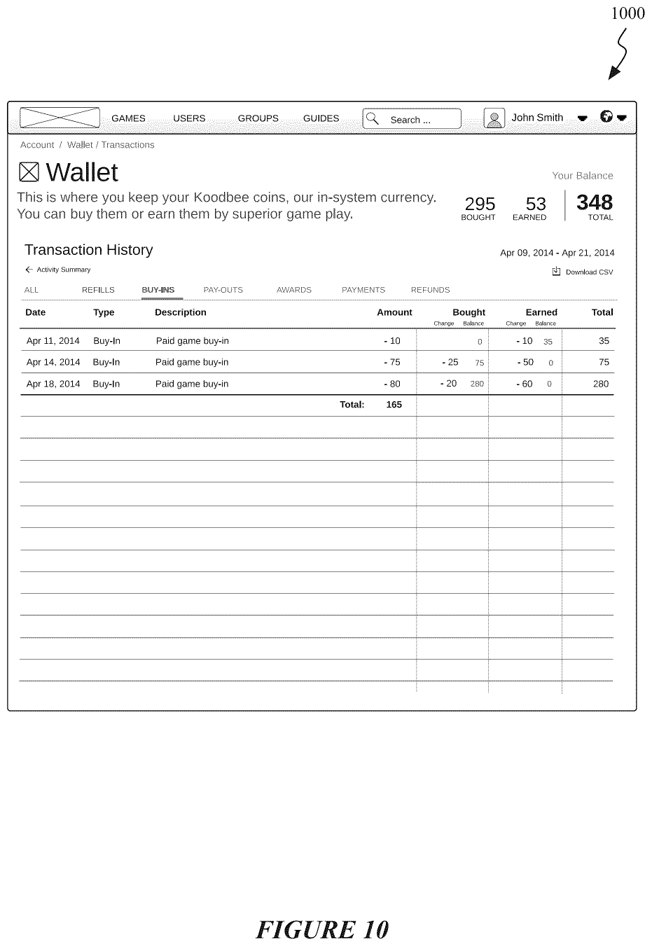

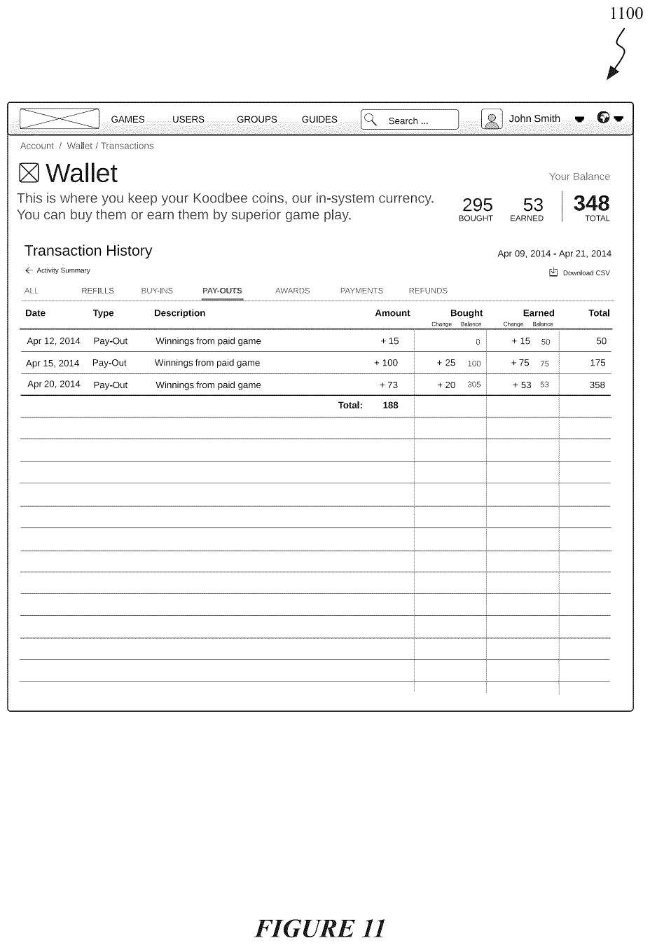

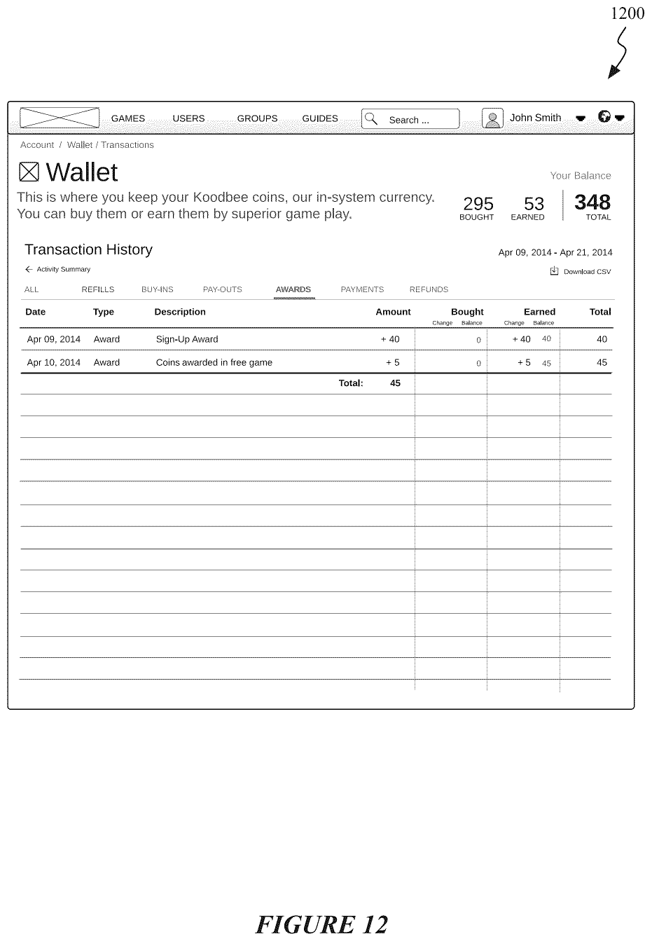

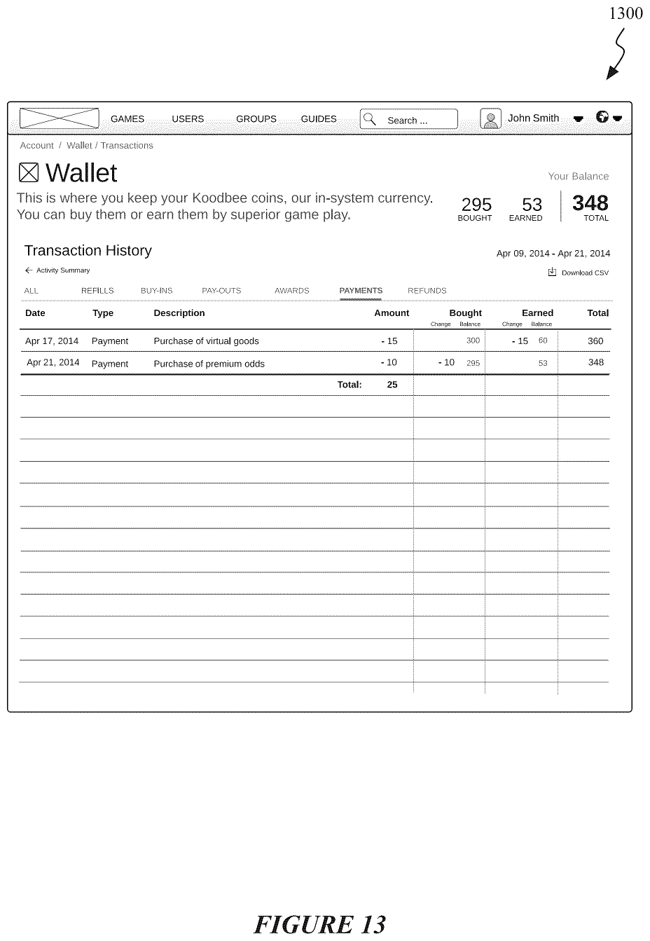

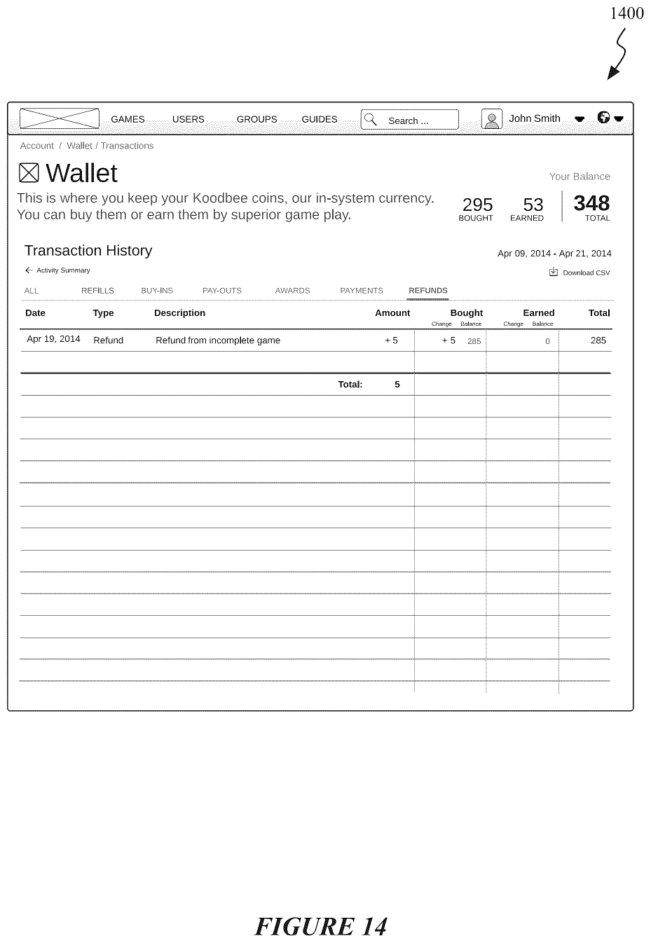

Various examples of wallet displays will now be discussed. FIG. 8 shows a wallet generally 800 having an unfiltered, full timespan view of all transactions, displaying the total amount of each transaction, the change and balance for each transaction, and the total balance. FIG. 9 shows a wallet generally 900 including a transaction history similar to that of FIG. 8 but filtered to only show refills. FIGS. 10 through 14 show wallets 1000 through 1400 with transaction histories filtered to show buy-ins, pay-outs, awards, payments, and refunds, respectively.

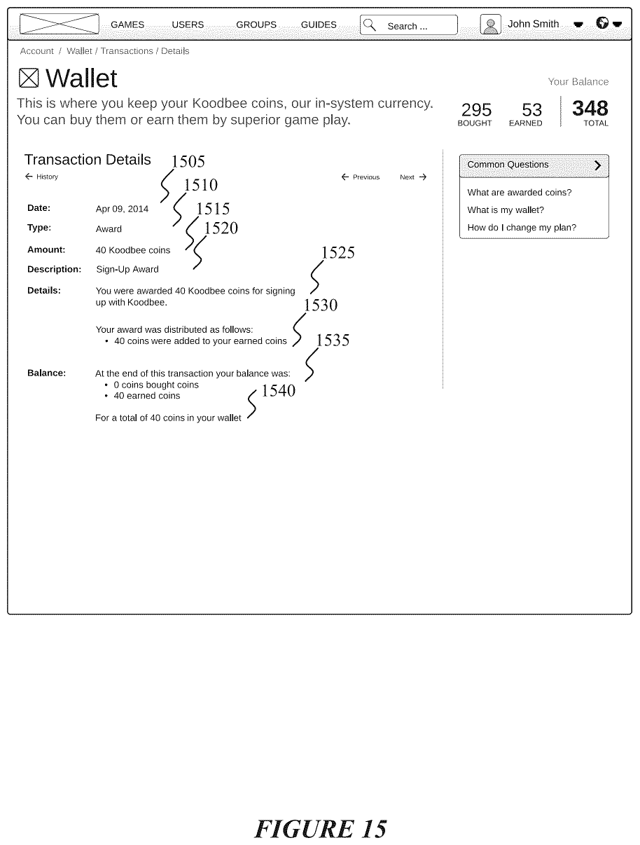

Each of FIGS. 15 through 27 shows a wallet giving full details of one transaction. FIG. 15 shows details of a single transaction in which 40 coins were awarded as a sign-up award. The details include a transaction date 1505, transaction type 1510, transaction amount 1515, transaction description 1520, detailed transaction description 1525, category and amount for draws and distributions 1530, available amount of virtual currency for each category 1535, and total amount of available virtual currency 1540.

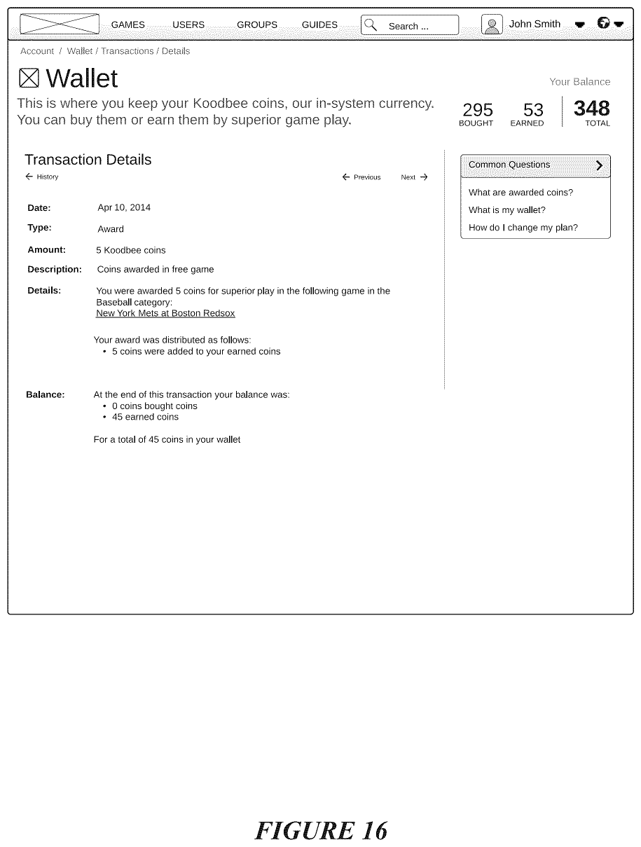

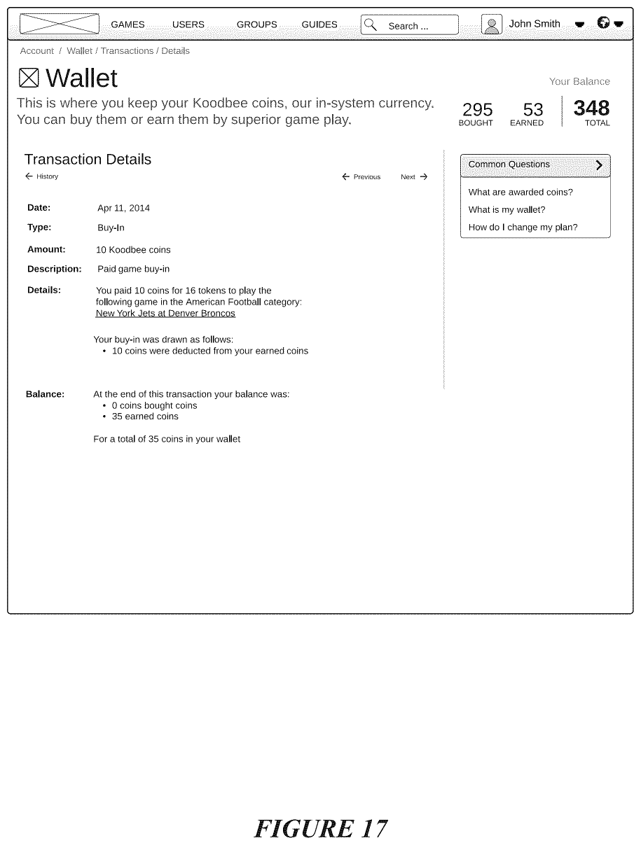

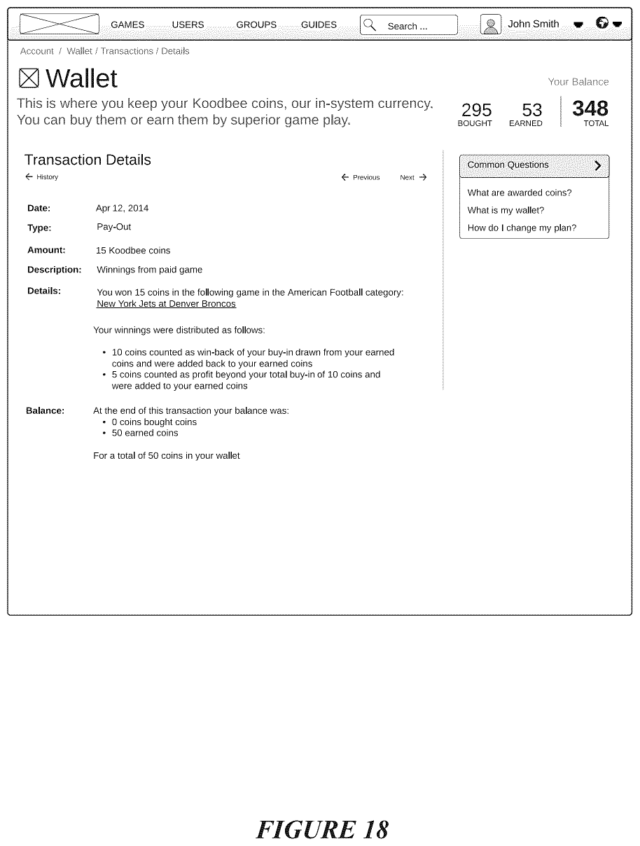

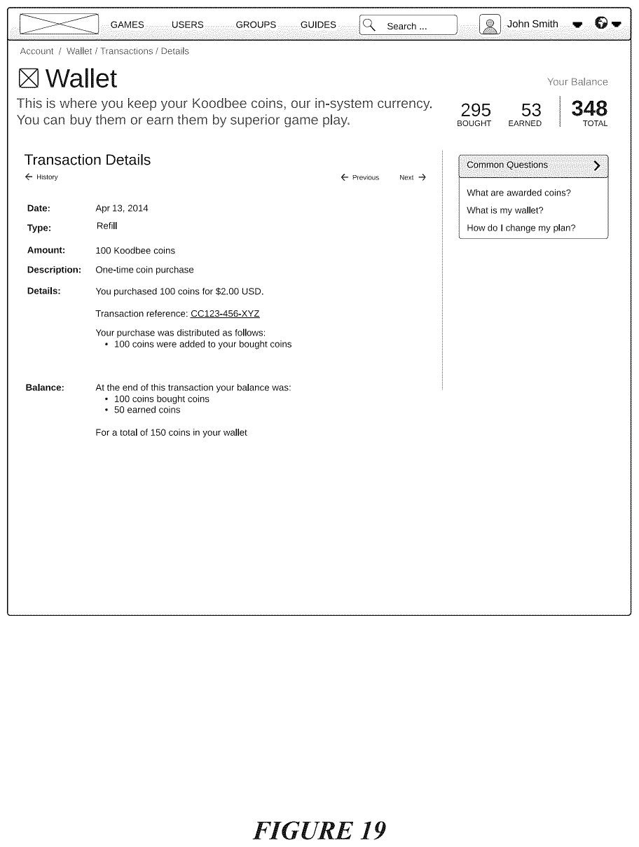

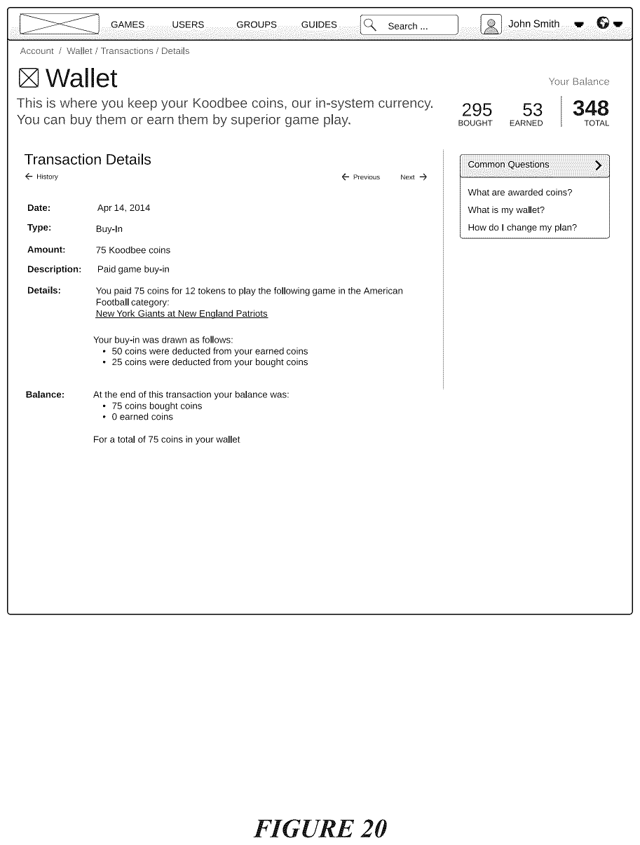

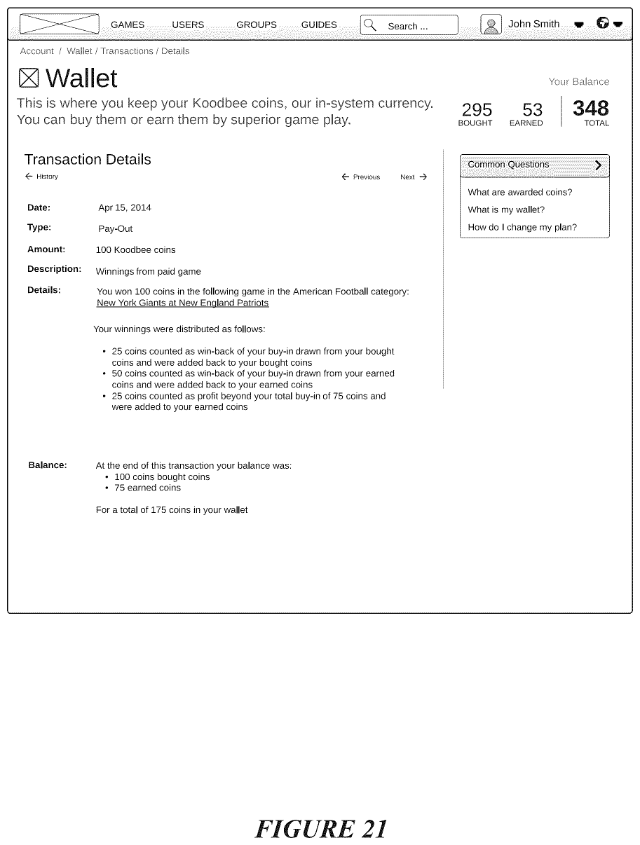

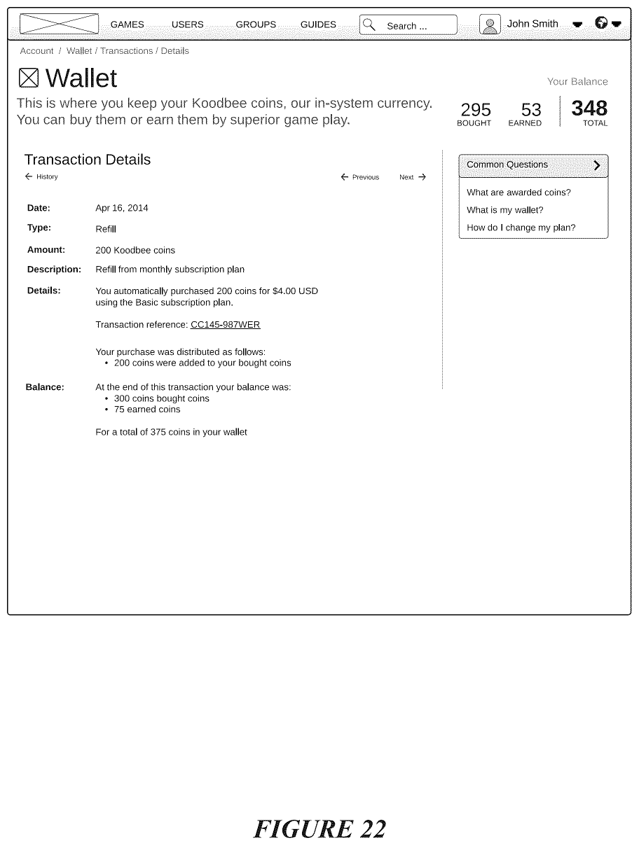

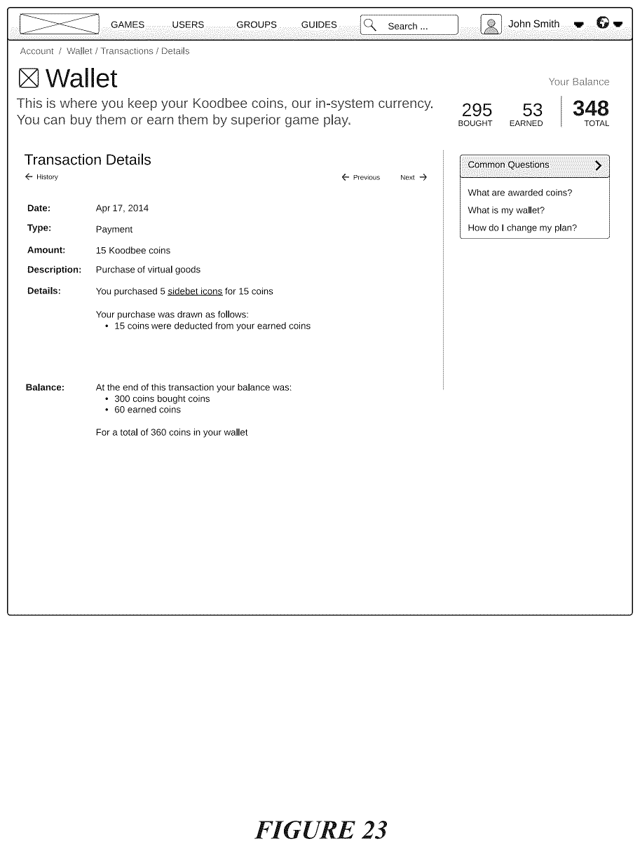

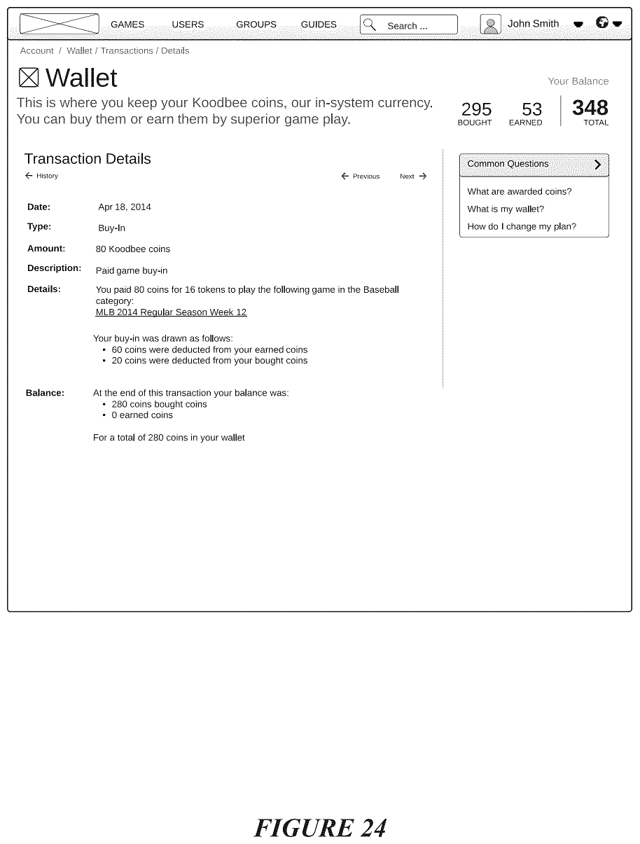

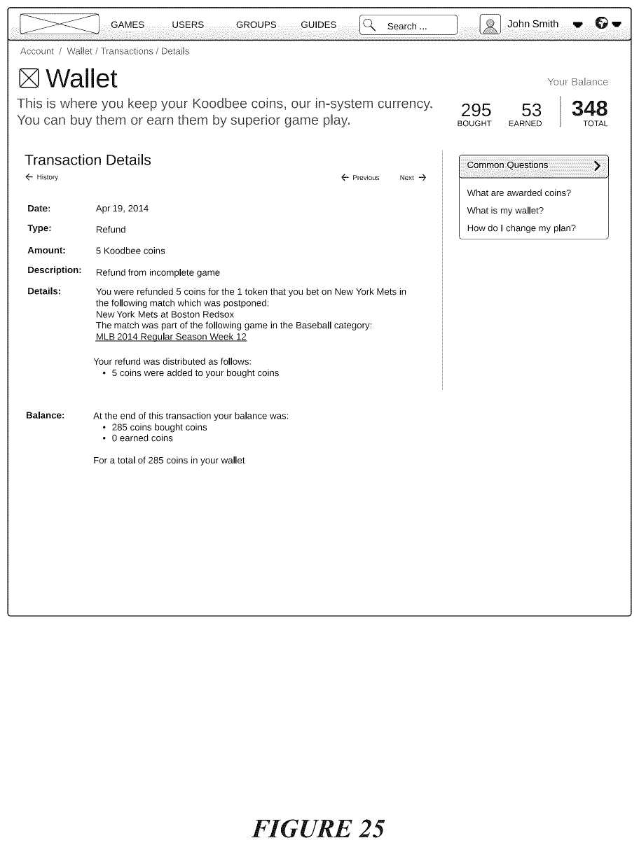

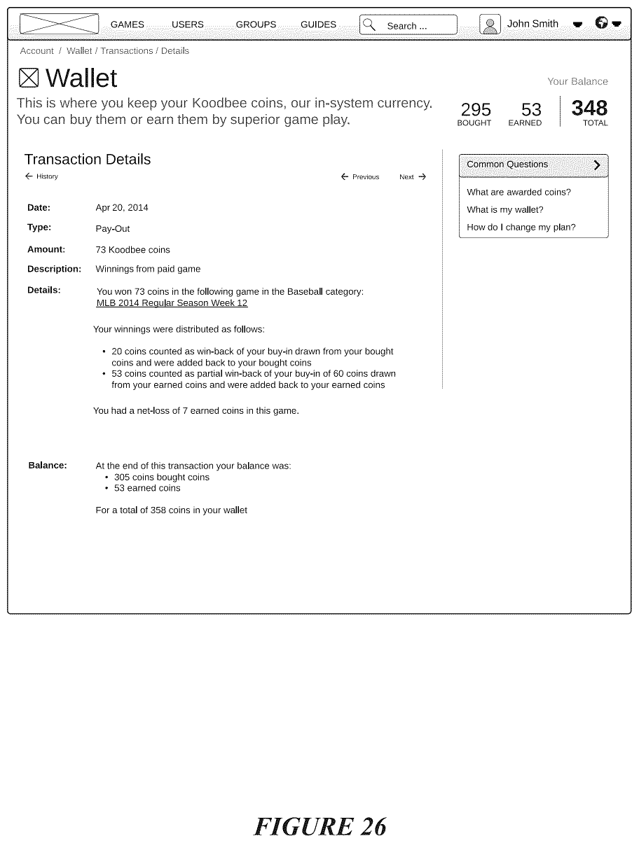

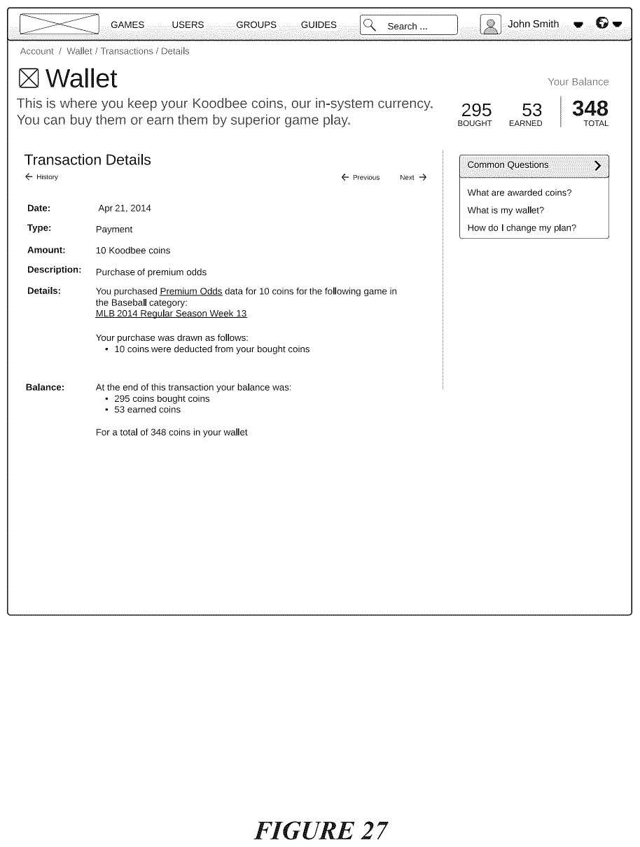

FIG. 16 shows details of an award transaction in which 5 coins were awarded in a free game. FIG. 17 shows details of a buy-in transaction in which 10 coins were used to obtain 16 tokens to play a game titled “New York Jets v. Denver Broncos” in the American Football category. FIG. 18 shows details of a pay-out transaction; FIG. 19, a refill; FIG. 20, another buy-in; FIG. 21, another pay-out; FIG. 22, another refill; FIG. 23, a payment; FIG. 24, another buy-in; FIG. 25, a refund; FIG. 26, another pay-out; and FIG. 27, another payment.

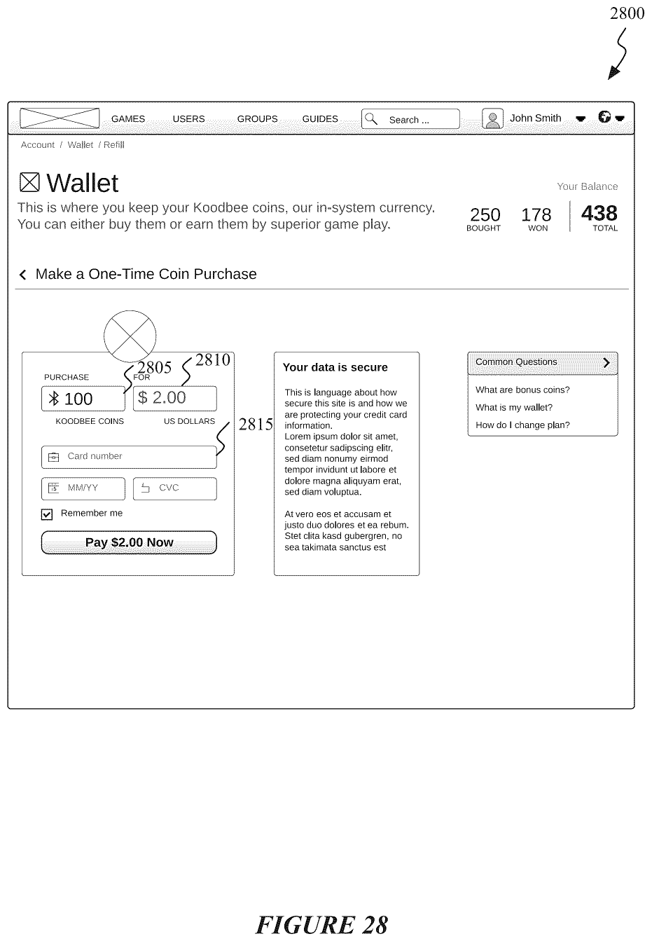

FIG. 28 gives an example of a one-time purchase of coins (virtual currency) in a wallet generally 2800. Such a purchase may be initiated, for example, by clicking a “purchase more coins” button such as the button in the “buy one-time refill” window 310 as shown in FIG. 3.

A “purchase more coins” interface may include a converter between “in-world currency” and “in-game currency.” For example, in the wallet of FIG. 28 a window 2805 and a window 2810 automatically display an amount in either window according to a value entered by the user in the other window. The converter can be set to calculate the amounts in the windows according to a pre-defined exchange rate. In this example the exchange rate is 50 in-game coins for one U.S. dollar, and the windows 2805 and 2810 show, respectively, that 100 coins can be bought for two dollars of U.S. currency. The user can enter payment details in a window 2815.

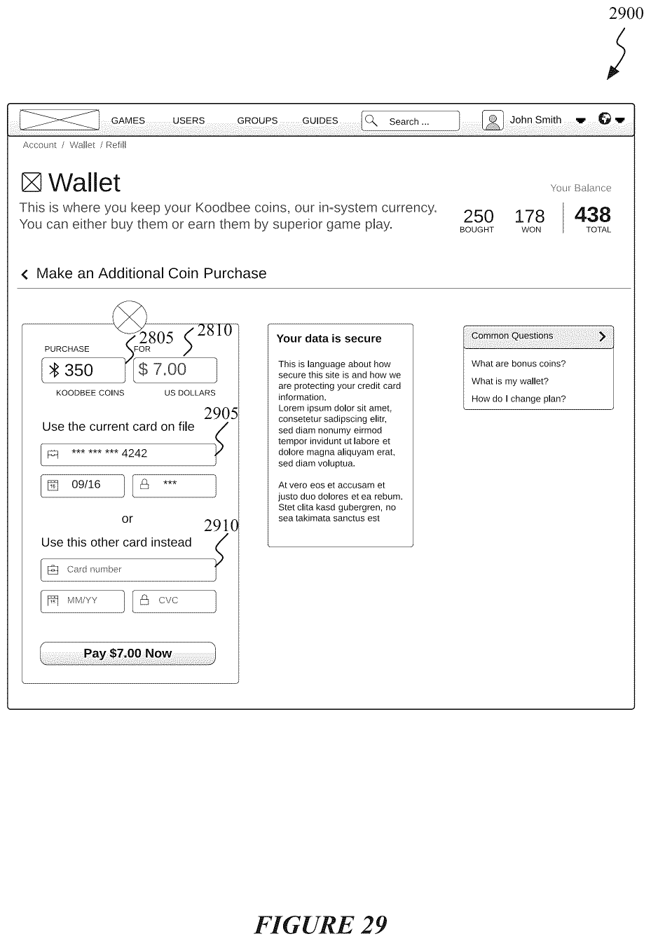

FIG. 29 gives an example of an additional coin purchase. Using the same exchange rate as in FIG. 28, 350 in-game coins being bought for $7.00 of U.S. currency. Credit card details have been entered in a credit card window 2905. An alternate credit card, or some other electronic payment credentials, can be entered through a window 2910.

Interfaces similar to those of FIGS. 28 and 29 can be used for other transactions involving in-world currency.

FIG. 30 illustrates a process for debiting coins from a wallet for a buy-in. A play of a paid game is begun (3000) and a buy-in is selected (3002). If the wallet does not have enough coins for the buy-in, the request is declined (3004) and process returns to permit the user to make another buy-in but in a smaller amount. Otherwise the amount of the buy-in is deducted from the user's wallet (3006). If the wallet has at least as many earned coins as the amount of the buy-in (3008), the amount of the buy-in is subtracted from the user's earned coins balance (3010). Otherwise the earned coins balance is subtracted from the amount of the buy-in (3012), resulting in the earned coin balance going to zero (3014), and the remaining amount of the buy-in is subtracted from the user's bought coin balance (3016). A record of the amount of bought coins used in the buy-in is stored (3018). Then a ticket is prepared (3020) either after storing the amount of bought coins (3018) or after subtracting the buy-in from earned coins (3010).

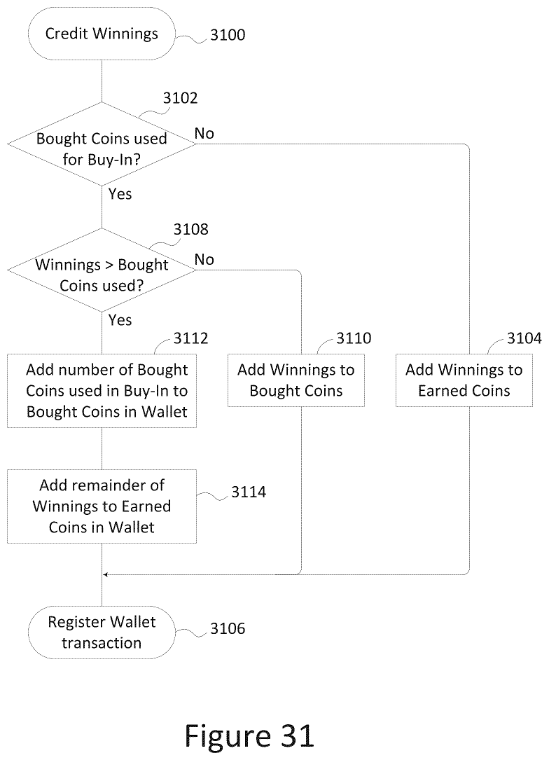

FIG. 31 shows how coins from a pay-out are credited (3100) to a user's wallet. If bought coins were not used for the buy-in (3102), the winnings are added to the user's earned coins (3104) and the wallet transaction is registered (3106). Otherwise if the winnings are not as much as any bought coins used (3108) the winnings are added to the user's bought coins (3110) and the wallet transaction is registered (3106). Otherwise the number of bought coins used in the buy-in is added to the bought coins already in the user's wallet (3112), the remainder of the winnings are added to the earned coins in the user's wallet (3114), and the wallet transaction is registered (3106).

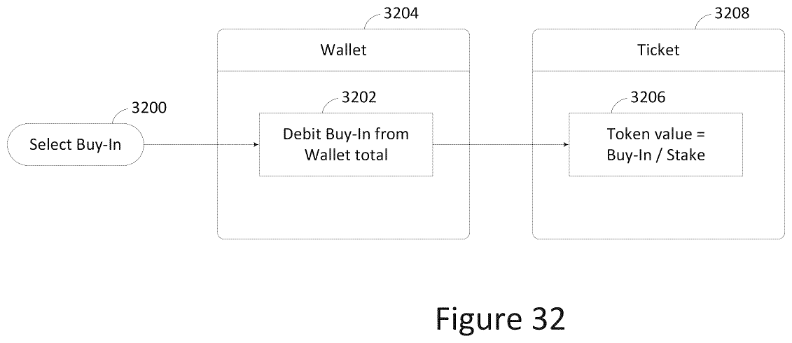

FIG. 32 illustrates how token values are calculated in a paid game. Each user is given the same number of tokens for each game; this number is the stake. In a paid game the user adds value to the stake by selecting a buy-in transaction (3200). The amount of the buy-in is debited (3202) from the user's wallet total. This reduction in the user's wallet total is reflected in the wallet 3204. Then the amount of the buy-in is divided by the stake (3206) to obtain the value of each token, as reflected in a ticket 3208.

For example, if two users are both playing a game with a stake of 20 tokens, and User A had paid 20 coins as a buy-in, and User B had paid 40 coins as a buy-in, User A would have a stake of 20 tokens each with a token value of 1 coin, and User B would have a stake of 20 tokens each with a token value of 2 coins.

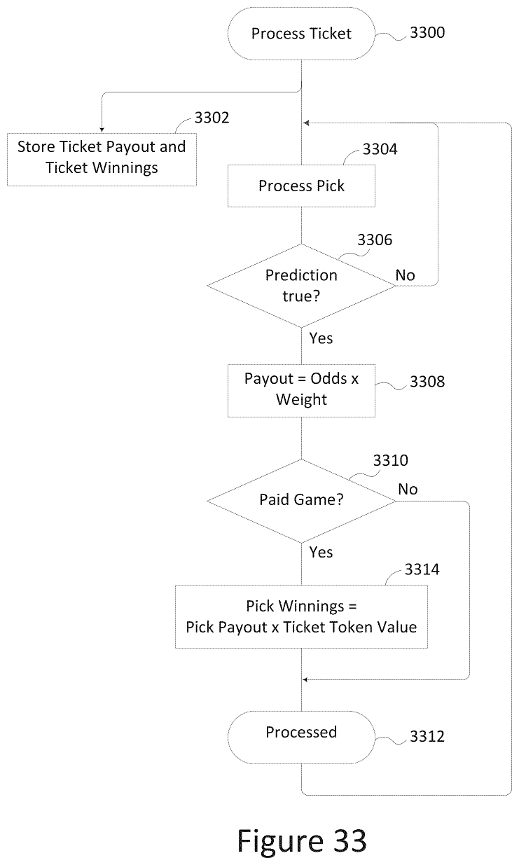

FIG. 33 depicts the processing of a user's pick. A Play::Pick model stores a weight of a user's pick; the weight is determined by the number of tokens placed on the pick. The winnings of a user in a paid game are calculated by multiplying the pay-out in tokens by the user's token value. The process starts with processing a ticket (3300). The ticket payout and ticket winnings are stored (3302). The user's pick is processed (3304) and if the user's prediction (pick) does not come true (3306) the process returns to another pick (3304). Otherwise the pay-out is calculated by multiplying the odds by the weight placed on the pick by the user (3308). If the game was not a paid game (3310) the result is processed (3312) and the process returns to another pick (3304). If the game was a paid game (3310) the pick winnings are calculated by multiplying the pick payout by the ticket token value (3314) and the result processed (3312).

The foregoing is a detailed description of some embodiments and aspects of this specification and is not intended to be limiting. Many other embodiments are possible. The only limitations are those in the claims.

1. A computer implemented, categorized virtual currency tracking, purchasing, and redemption game-playing wallet operation method comprising:
providing, by a computer system, an automated wallet interface display over a communication network;
receiving, by the computer system, electronic payments from a first user through the automated wallet interface display for bought-coin virtual currency;
providing, by the computer system, through the automated wallet interface display a tally of the first user's bought-coin virtual currency;
providing, by the or another computer system, an automated game in response to a request from the first user;
providing, by the computer system, through the automated wallet interface display a tally of any earned-coin virtual currency acquired by the first user from playing the automated game;
applying, by the computer system, a first rule to reduce the bought-coin virtual currency if and only if the earned virtual currency is not sufficient to meet a given transaction amount;
applying, by the computer system, a second to rule to increase the bought-coin virtual currency in advance of categorizing excess amounts as earned-coin virtual currency;
debiting, by the computer system, at least one of the first user's tallies of bought-coin and earned-coin virtual currency for any game fee; and
providing, by the computer system, through the automated wallet interface display a combined tally of the first user's bought-coin and earned-coin virtual currencies.

2. The computer implemented, categorized, virtual currency tracking, purchasing, and redemption game-playing wallet operation method of claim 1 and further comprising automatically collecting, by the computer system, electronic payments from the first user at periodic intervals for bought-coin virtual currency in an amount preselected by the first user.

3. The computer implemented, categorized, virtual currency tracking, purchasing, and redemption game-playing wallet operation method of claim 1 and further comprising automatically collecting, by the computer system, one or more electronic payments from the first user from time to time for bought-coin virtual currency in amounts sufficient to maintain the first user's tally of bought-coin virtual currency at a minimum level preselected by the first user.

4. The computer implemented, categorized, virtual currency tracking, purchasing, and redemption game-playing wallet operation method of claim 1 and further comprising automatically increasing, by the computer system, the first user's tally of bought-coin virtual currency responsive to an electronic refund resulting from an event beyond the first user's control.

5. The computer implemented, categorized, virtual currency tracking, purchasing, and redemption game-playing wallet operation method of claim 1 wherein providing a tally of any earned-coin virtual currency comprises:
crediting, by the computer system, the first user's tally of bought-coin virtual currency by any amount acquired by the first user from playing the game up to any amount of bought-coin virtual currency paid by the first user as a game fee; and
crediting, by the computer system, the user's tally of earned-coin virtual currency by amount acquired by the first user from playing the game in excess of the amount of bought-coin virtual currency paid by the first user as a game fee.

6. The computer implemented, categorized virtual currency tracking, purchasing, and redemption game-playing wallet operation method of claim 1 and further comprising:
receiving, by the or another computer system, from the first user a prediction of an occurrence in the game by a second user;
forming, by the or another computer system, a pick by weighting the prediction according to an amount of earned-coin virtual currency selected by the first user;
debiting, by the computer system, the first user's tally of earned-coin virtual currency in the automated wallet interface display by the amount of the pick; and
if the prediction comes true, crediting, by the computer system, the first user's tally of earned-coin virtual currency in the automated wallet interface display by a multiple of the amount of the pick.

7. The computer implemented, categorized virtual currency tracking, purchasing, and redemption game-playing wallet operation method of claim 1 wherein providing a game by the or another computer system comprises:
providing a predetermined number of tokens to the first user as a stake;
fixing a per-token value for the tokens in the first user's stake according to an amount of bought-coin virtual currency selected by the first user and debited from the first user's tally of bought-coin virtual currency in the automated wallet interface display;
providing the same predetermined number of tokens as a stake to a second user; and
fixing a per-token value for the tokens in the second user's stake according to an amount of bought-coin virtual currency selected by the second user and debited from the second user's tally of bought-coin virtual currency in the automated wallet interface display.

8. The computer implemented, categorized virtual currency tracking, purchasing, and redemption game-playing wallet operation method of claim 7 and further comprising receiving, by the or another computer system, from the first user permission for the second user to make a pick using tokens from the first user's stake according a prediction of an occurrence in the game by the second user.

9. A computer implemented, categorized virtual currency tracking, purchasing, and redemption game-playing wallet operation system comprising a computer network programmed to:
generate an automated wallet interface on a user display;
maintain a tally of bought-coin virtual currency, a tally of earned-coin virtual currency, and a combined tally of both bought-coin and earned-coin virtual currencies; and
display the tallies in the automated wallet interface on the display, the computer network being responsive to:
a user's command to purchase bought-coin virtual currency, by collecting an electronic payment from an account of the user and crediting the tally of bought-coin virtual currency;
a user's command to play a game, by providing a game on the or another user display, and automatically debiting at least one of the tallies of bought-coin and earned-coin virtual currency in payment if the game requires a payment;
a first rule directing the game-playing wallet operation system to reduce the bought-coin virtual currency if and only if the earned virtual currency is not sufficient to meet a given transaction amount; and
a second rule directing the game-playing wallet operation system to increase the bought-coin virtual currency in advance of categorizing excess amounts as earned-coin virtual currency.

10. The computer implemented categorized virtual currency tracking, purchasing, and redemption game-playing wallet operation system of claim 9 wherein the computer network comprises a central processor and a communication link to the user display.

11. The computer implemented, categorized virtual currency tracking, purchasing, and redemption game-playing wallet operation system of claim 9 wherein the computer network is responsive to a user's command to buy electronic virtual currency at periodic intervals, by automatically collecting an electronic payment from the account of the user at each interval and crediting the tally of bought-coin virtual currency.

12. The computer implemented, categorized virtual currency tracking, purchasing, and redemption game-playing wallet operation system of claim 9 wherein the computer network is responsive to a user's command to maintain a minimum tally of bought-coin virtual currency, by automatically collecting an electronic payment from the account of the user from time to time in amounts sufficient to maintain the tally of bought-coin virtual currency at the minimum selected by the user and crediting the tally of bought-coin virtual currency.

13. The computer implemented, categorized virtual currency tracking, purchasing, and redemption game-playing wallet operation system of claim 9 wherein the computer network is programmed to automatically credit the user's tally of bought-coin virtual currency if the user becomes entitled to an electronic refund resulting from an event beyond the user's control.

14. The computer implemented categorized virtual currency tracking, purchasing, and redemption game-playing wallet operation system of claim 9 wherein the computer network is programmed to automatically credit the user's tally of bought-coin virtual currency by any amount acquired by the user from playing a game up to any amount of bought-coin virtual currency paid for the game by the user, and to automatically credit the user's tally of earned-coin virtual currency by any amount acquired by the first user from playing the game in excess of the amount of bought-coin virtual currency paid for the game by the user.

15. The computer implemented, categorized virtual currency tracking, purchasing, and redemption game-playing wallet operation system of claim 9 wherein the computer network is programmed to:
receive from a user a prediction of a game event;
receive from the user a selection of an amount of earned-coin virtual currency;
automatically weight the prediction according to the selection to form a pick;
automatically debit the user's tally of earned-coin virtual currency according to the pick, and
automatically assess if the prediction comes true, and if so, automatically credit the user's tally of earned-coin virtual currency according to the pick.

16. The computer implemented categorized virtual currency tracking, purchasing, and redemption game-playing wallet operation system of claim 15 wherein the computer network is programmed to:
provide a predetermined number of tokens to a first user as a stake, receive from the first user a selection of an amount of bought-coin virtual currency, automatically debit the selected amount from the first user's tally of bought-coin virtual currency, and automatically fix a per-token value for the tokens in the first user's stake according to the selected amount;
provide the same number of tokens as a stake to a second user, receive from the second user a selection of an amount of bought-coin virtual currency, automatically debit the selected amount from the second user's tally of bought-coin virtual currency, and automatically fix a per-token value for the tokens in the second user's stake according to the selected amount; and
receive from the first user permission for the second user to make a pick using tokens from the first user's stake.

17. The computer implemented, categorized virtual currency tracking, purchasing, and redemption game-playing wallet operation method of claim 1 and further comprising:
automatically applying a third rule to reduce the earned-coin virtual currency before reducing the bought-coin virtual currency; and
automatically applying a fourth rule to increase the earned-coin virtual currency only after reducing the bought-coin virtual currency.

18. The computer implemented, categorized virtual currency tracking, purchasing, and redemption game-playing wallet operation system of claim 9 wherein the computer network is automatically responsive to:
a third rule automatically directing the system to reduce the earned-coin virtual currency before reducing the bought-coin virtual currency; and
a fourth rule automatically directing the system to increase the earned-coin virtual currency only after reducing the bought-coin virtual currency.
